(19) United States
(12) Patent Application Publication
(10) Pub. No.: US 2021/0131084 A1
(43) Pub. Date: May 6, 2021

(54) Toilet Clearing Vacuum Attachment Apparatus

(71) Applicant: George Holt, Southfield, MI (US)

(72) Inventor: George Holt, Southfield, MI (US)

(21) Appl. No.: 16/669,725

(22) Filed: Oct. 31, 2019

(51) Int. Cl. E03C 1/30; A47L 7/00; B08B 9/035

(52) U.S. Cl. CPC E03C 1/30; A47L 7/009; B08B 9/035; A47L 7/0004

(57) ABSTRACT

A toilet clearing vacuum attachment apparatus for clearing a clogged toilet includes a rigid connector. The connector is cylindrical and configured to attach to an intake of a wet vacuum. A hose is coupled to the connector. The hose has a cylindrical portion extending from the connector and a D-shaped toilet portion extending from the cylindrical portion. A rigid tip is coupled to a distal end of the toilet portion of the hose. The rigid tip is an extruded D-shape configured to fit within a trap of a toilet.

### (a) TITLE OF THE INVENTION

TOILET CLEARING VACUUM ATTACHMENT APPARATUS

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to vacuum attachments and more particularly pertains to a new vacuum attachment for clearing a clogged toilet.

### (2) Description of Related Art including information disclosed under 37 CFR 1.97 and 1.98

The prior art relates to vacuum attachments.

### (h) BRIEF SUMMARY OF THE INVENTION

An embodiment of the disclosure meets the needs presented above by generally comprising a rigid connector. The connector is cylindrical and configured to attach to an intake of a wet vacuum. A hose is coupled to the connector. The hose has a cylindrical portion extending from the connector and a D-shaped toilet portion extending from the cylindrical portion. A rigid tip is coupled to a distal end of the toilet portion of the hose. The rigid tip is an extruded D-shape configured to fit within a trap of a toilet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a toilet clearing vacuum attachment apparatus according to an embodiment of the disclosure.

FIG. 2 is an isometric in-use view of an embodiment of the disclosure.

FIG. 3 is a detail view of an embodiment of the disclosure.

### (j) DETAILED DESCRIPTION OF THE INVENTION

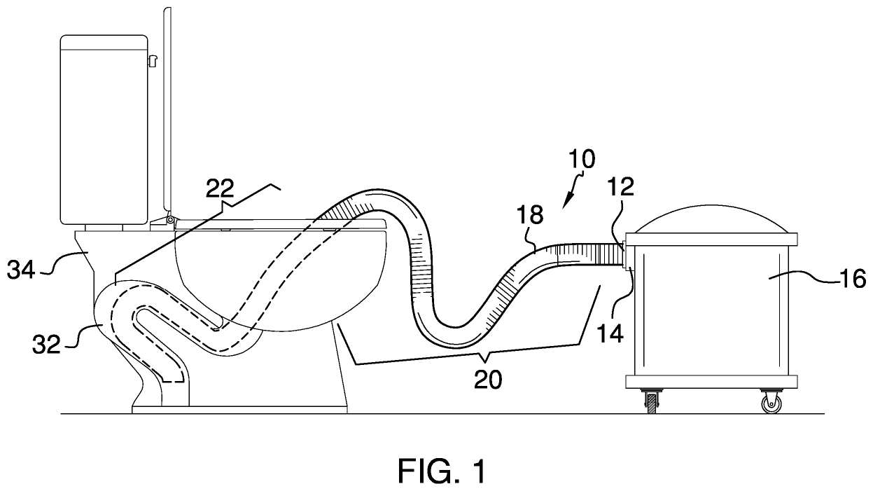

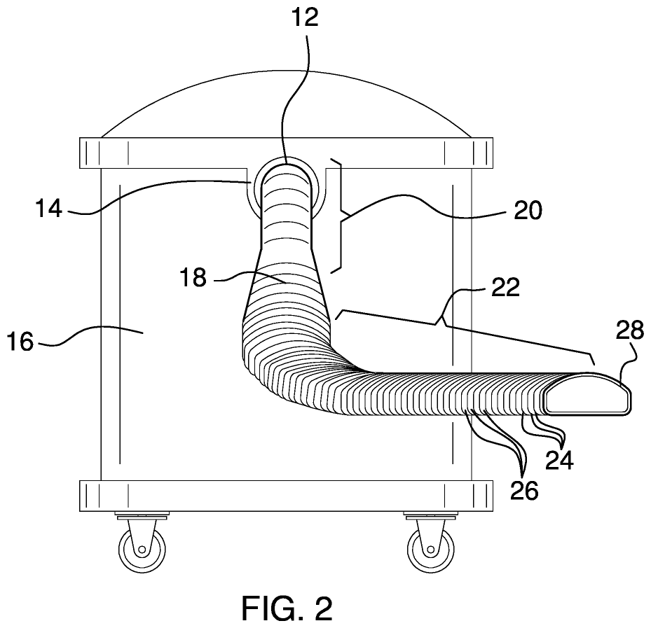

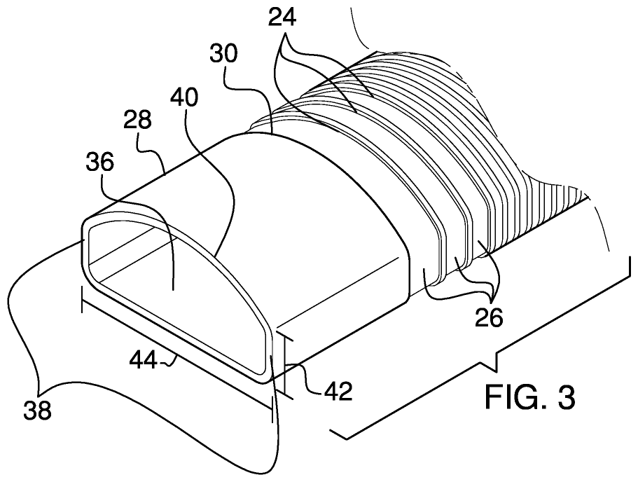

With reference now to the drawings, and in particular to FIGS. 1 through 3 thereof, a new vacuum attachment embodying the principles and concepts of an embodiment of the disclosure and generally designated by the reference numeral 10 will be described.

As best illustrated in FIGS. 1 through 3, the toilet clearing vacuum attachment apparatus 10 generally comprises a rigid connector 12. The connector 12 is cylindrical and configured to attach to an intake 14 of a wet vacuum 16. A hose 18 is coupled to the connector 12. The hose 18 has a cylindrical portion 20 extending from the connector 12 and a D-shaped toilet portion 22 extending from the cylindrical portion 20. The hose 18 has a plurality of ridges 24 and a plurality of collapsible extension portions 26 extending between each adjacent ridge 24. The ridges 24 and the extension portions 26 allow the hose 18 to be flexible and to perform an accordion style collapse or expansion. A rigid tip 28 is coupled to a distal end 30 of the toilet portion. The rigid tip 28 is an extruded D-shape configured to fit within a trap 32 of a toilet 34. The rigid tip 28 may have a flat bottom portion 36, a pair of parallel sidewalls 38 perpendicularly extending from the flat bottom portion 36, and a curved top portion 40 arching between the pair of sidewalls 38. A height 42 of each sidewall 38 may be less than 25% of a width 44 of the bottom portion 36.

In use, the connector 12 is attached to the intake 14 of the wet vacuum 16. The rigid tip 28 and the toilet portion 22 of the hose are inserted into the trap 32 of the toilet 34. The wet vacuum 16 is then activated to clear out whatever may be blocking the trap 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A toilet clearing vacuum attachment apparatus comprising:
a rigid connector, the connector being cylindrical and configured to attach to an intake of a wet vacuum;
a hose coupled to the connector, the hose having a cylindrical portion extending from the connector and a D-shaped toilet portion extending from the cylindrical portion; and
a rigid tip coupled to the hose, the rigid tip being coupled to a distal end of the toilet portion, the rigid tip being an extruded D-shape configured to fit within a trap of a toilet.

2. The toilet clearing vacuum attachment apparatus of claim 1 further comprising the rigid tip having a flat bottom portion, a pair of parallel sidewalls perpendicularly extending from the flat bottom portion, and a curved top portion arching between the pair of sidewalls.

3. The toilet clearing vacuum attachment apparatus of claim 2 further comprising a height of each sidewall being less than 25% of a width of the bottom portion.

4. The toilet clearing vacuum attachment apparatus of claim 1 further comprising the hose having a plurality of ridges and a plurality of collapsible extension portions extending between each adjacent ridge, the ridges and the extension portions allowing the hose to be flexible and to perform an accordion style collapse or expansion.

5. A toilet clearing vacuum attachment apparatus comprising:
a rigid connector, the connector being cylindrical and configured to attach to an intake of a wet vacuum;
a hose coupled to the connector, the hose having a cylindrical portion extending from the connector and a D-shaped toilet portion extending from the cylindrical portion, the hose having a plurality of ridges and a plurality of collapsible extension portions extending between each adjacent ridge, the ridges and the extension portions allowing the hose to be flexible and to perform an accordion style collapse or expansion; and
a rigid tip coupled to the hose, the rigid tip being coupled to a distal end of the toilet portion, the rigid tip being an extruded D-shape configured to fit within a trap of a toilet, the rigid tip having a flat bottom portion, a pair of parallel sidewalls perpendicularly extending from the flat bottom portion, and a curved top portion arching between the pair of sidewalls, a height of each sidewall being less than 25% of a width of the bottom portion.

6. A toilet clearing vacuum attachment apparatus and vacuum system comprising:
a wet vacuum;
a rigid connector, the connector being cylindrical and configured to attach to an intake of the wet vacuum;
a hose coupled to the connector, the hose having a cylindrical portion extending from the connector and a D-shaped toilet portion extending from the cylindrical portion, the hose having a plurality of ridges and a plurality of collapsible extension portions extending between each adjacent ridge, the ridges and the extension portions allowing the hose to be flexible and to perform an accordion style collapse or expansion; and
a rigid tip coupled to the hose, the rigid tip being coupled to a distal end of the toilet portion, the rigid tip being an extruded D-shape configured to fit within a trap of a toilet, the rigid tip having a flat bottom portion, a pair of parallel sidewalls perpendicularly extending from the flat bottom portion, and a curved top portion arching between the pair of sidewalls, a height of each sidewall being less than 25% of a width of the bottom portion.
